(19) United States
(12) Patent Application Publication
(10) Pub. No.: US 2026/0079703 A1
(43) Pub. Date: Mar. 19, 2026

(54) Chaos Testing Prioritization Via Smart Weights Inference

(71) Applicant: Dell Products L.P., Round Rock, TX (US)

(72) Inventors: Boris Shpilyuck, Ashdod (IL); Nisan Haimov, Beer-Sheva (IL); Igor Dubrovsky, Beer-Sheva (IL)

(21) Appl. No.: 18/888,071

(22) Filed: Sep. 17, 2024

(51) Int. Cl. G06F 9/26; G06F 11/34

(52) U.S. Cl. CPC G06F 9/268; G06F 11/3438

(57) ABSTRACT

A system can identify respective first accessibility weights associated with at least some application programming interfaces (APIs) of respective APIs exposed by respective microservices of a group of microservices of a microservice architecture. The system can determine a second accessibility weight for an API of the respective APIs based on how often the API is invoked with at least a subset of the respective APIs, and based on second respective accessibility weights of the respective first accessibility weights that are associated with at least the subset of the respective APIs. The system can determine respective total accessibility weights for the respective microservices based on the first accessibility weights and the second accessibility weight. The system can, based on the respective total accessibility weights, determine a selected microservice of the group of microservices on which to perform chaos testing. The system can perform the chaos testing on the selected microservice.

### BACKGROUND

Microservices can generally be a variant of a service-oriented architecture (SOA) computer architectural style that structures an application as a collection of loosely coupled services. Microservices can be deployed as part of a software as a service (SaaS) model, where a system of microservices is centrally hosted, and is accessed by a thin client (e.g., a web browser).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify respective first accessibility weights associated with at least some application programming interfaces of respective application programming interfaces exposed by respective microservices of a group of microservices of a microservice architecture. The system can determine a second accessibility weight for an application programming interface of the respective application programming interfaces based on how often the application programming interface is invoked with at least a subset of the respective application programming interfaces, and based on second respective accessibility weights of the respective first accessibility weights that are associated with at least the subset of the respective application programming interfaces. The system can determine respective total accessibility weights for the respective microservices based on the first accessibility weights and the second accessibility weight. The system can, based on the respective total accessibility weights, determine at least one selected microservice of the group of microservices on which to perform chaos testing. The system can perform the chaos testing on the at least one selected microservice.

An example method can comprise identifying, by a system comprising at least one processor, respective first accessibility weights associated with at least some respective application programming interfaces of application programming interfaces that are exposed by respective microservices of a microservices architecture. The method can further comprise determining, by the system, a second accessibility weight for an application programming interface of the application programming interfaces based on how often the application programming interface is invoked with at least a subset of the application programming interfaces, and based on second respective accessibility weights of the respective first accessibility weights that are associated with at least the subset of the application programming interfaces. The method can further comprise determining, by the system, respective total accessibility weights for the respective microservices based on the first accessibility weights and the second accessibility weight. The method can further comprise, based on the respective total accessibility weights, determining, by the system, a selected microservice of the microservices on which to perform chaos testing. The method can further comprise performing, by the system, the chaos testing on the selected microservice.

An example non-transitory computer-readable medium can comprise instructions that, in response to execution, cause a system comprising a processor to perform operations. These operations can comprise identifying respective first accessibility weights associated with at least some respective application programming interfaces that are exposed by respective microservices of a microservices architecture. These operations can further comprise determining a second accessibility weight for an application programming interface of the application programming interfaces based on a frequency with which the application programming interface is invoked with at least a subset of the application programming interfaces, and based on second respective accessibility weights of the respective first accessibility weights that are associated with at least the subset of the application programming interfaces. These operations can further comprise determining respective total accessibility weights for the respective microservices based on the first accessibility weights and the second accessibility weight. These operations can further comprise performing chaos testing on a selected microservice of the microservices based on the respective total accessibility weights.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate chaos testing prioritization via smart weights inference, in accordance with an embodiment of this disclosure;

FIG. 2 illustrates an example that can facilitate chaos testing prioritization via smart weights inference, in accordance with an embodiment of this disclosure;

FIG. 3 illustrates an example of weights for microservice application programming interfaces, and that can facilitate chaos testing prioritization via smart weights inference, in accordance with an embodiment of this disclosure;

FIG. 4 illustrates an example of specified weights for microservice application programming interfaces, and that can facilitate chaos testing prioritization via smart weights inference, in accordance with an embodiment of this disclosure;

FIG. 5 illustrates an example of inferred weights for microservice application programming interfaces, and that can facilitate chaos testing prioritization via smart weights inference, in accordance with an embodiment of this disclosure;

FIG. 6 illustrates an example of determining weights for microservices based on weights for microservice application programming interfaces, and that can facilitate chaos testing prioritization via smart weights inference, in accordance with an embodiment of this disclosure;

FIG. 7 illustrates an example process flow that can facilitate chaos testing prioritization via smart weights inference, in accordance with an embodiment of this disclosure;

FIG. 8 illustrates another example process flow that can facilitate chaos testing prioritization via smart weights inference, in accordance with an embodiment of this disclosure;

FIG. 9 illustrates another example process flow that can facilitate chaos testing prioritization via smart weights inference, in accordance with an embodiment of this disclosure;

FIG. 10 illustrates another example process flow that can facilitate chaos testing prioritization via smart weights inference, in accordance with an embodiment of this disclosure; and

FIG. 11 illustrates an example block diagram of a computer operable to execute an embodiment of this disclosure.

### DETAILED DESCRIPTION

### Overview

Chaos testing can comprise a discipline of experimenting on a software system in order to build confidence in the system's capability to withstand turbulent and unexpected conditions.

Chaos testing can involve creating continuous, random, or systematic failures to the system (like killing a service instance, throttling the traffic to or from a service, etc.), and testing the ability of the system to overcome such failures. After failure injection, the system can be analyzed in order to understand the impact the failure had on the system. In some examples, this analysis can be a complex and time-consuming process, so a practical approach can be to inject the failures into a subset of the most critical microservices.

In examples of a typical microservices environment, an application can comprise hundreds or even thousands of the microservices. Therefore, it can become challenging to decide on the subset of the most critical microservices (system stability-wise) that should undergo the chaos testing.

The present techniques can be implemented to mitigate against these problems with chaos testing. In some examples, an accessibility weight (AW) can be attached to each application programming interface (API) within an application, indicating the importance of the API to the accessibility of a system that implements the present techniques (where accessibility can indicate the system being accessible to process requests). The system can utilize the total AWs of the APIs comprising each microservice to determine a service priority for a chaos testing process.

Additionally, the system can identify APIs that may not initially seem critical, as indicated by their relatively low assigned AWs by system owners, but in fact possess hidden significance due to the nature of the business. For those APIs the system will rectify their AWs, so the significance of the microservices that host those APIs will be reflected more accurately in terms of their selection for chaos testing.

There can be a problem associated with prioritizing the selection of microservices for chaos testing. Allocating excessive resources to chaos testing can affect resources, budgets, and manpower. Therefore, it would be beneficial to have an approach that allows/achieves a balance between those concerns. Being able to perform chaos testing on the most critical parts of the system can provide a reasonable confidence in the resiliency of the system, while dedicating the reasonable amount of resources for the chaos testing process.

There can be a problem associated with deciding on an appropriate set of the microservices for the chaos testing. The decision on the appropriate set of the microservices for the chaos testing can be complicated because:

There can be hundreds or even thousands of the microservices, so it can be that the prioritization for chaos testing selection should be done among them based on some criteria. However how this criteria can be defined and expressed quantifiably can be challenging.

The situation can change dynamically over time as code is being developed.

So there can be a need for criteria that can be dynamically applied for the selection of the microservices, and evolve with the solution.

It can be possible to deduce a significance of the microservice for the chaos testing based on the significance of its APIs for the availability of the whole system. But, determining the significance of the APIs can be a problem.

Therefore, to be able to prioritize the microservices for the chaos testing, there can be a need to address these issues.

In some examples, the present techniques can be implemented to determine a most suitable (or suitable) subset of the microservices that will undergo chaos testing, by determining services that are considered critical (or suitably important) for overall system accessibility. That is, these can be services for which failure in any one of them will probably have a significant impact on the accessibility of the whole system.

In some examples, the present techniques can generally be implemented in two parts:

Inferring accessibility weights (AW) for the microservices APIs. This part can deal with defining AWs and adjusting AWs due to a “hidden significance” of the APIs for the accessibility of a system that implements the present techniques.

Using AWs to deduce the “significance” of the microservices for the chaos testing, and managing the microservices selection process based on the deduced “significance.”

The present techniques can be implemented to infer accessibility weights for microservices APIs.

An AW can comprise a numerical metric, and it can be incorporated into a service's API. The metric can reflect the significance of a particular API for the accessibility of the system. The metric's value can be provided by the owner of each API (and, in some examples, reviewed by a system operator or another person within an organization).

In some examples, part of the APIs can have a “hidden significance” associated with them even though system owners are not aware of it. For example:

A/comments API might seem not to be critical in a commercial product, but it might be used often with a critical/purchase API, because users want to see comments about a product before they purchase it.

In a backup solution/backup can be a critical API. And it can be commonly used with/report/{vm} API (which could seem less critical) to see how often a virtual machine (VM) is accessed before determining how tight the backup schedule should be.

This type of runtime business-related behavior can be taken into consideration when deciding on the significance of the APIs like/comments.

To track that “hidden significance,” a subset of critical (or suitably important) APIs for the system can be labeled as such, such as by system operators.

The system, during a learning period, can track the users'sessions and can verify the correlations between the APIs invoked within the sessions (in some examples, this can be done based on cookies, tokens, or another session identifier). Each API A that is invoked X % of time with any of the critical APIs having weight W, can be assigned a weight candidate of W*X/100. If there are many critical APIs to which API A is correlated, the result of the determination above can be aggregated across all of them. Where the final result is bigger than original weight that was assigned to A, this final result will replace the original weight of A.

This process of determining weights can be performed periodically according to a schedule provided (such as one provided by a system operator), or on demand in order to accommodate the changes to the codebase and new usage patterns.

At the end of a learning period, some of the APIs can be assigned new accessibility weight suggestions (AWs) that can be either applied to the system automatically, or provided for a review to system operators and applied upon their confirmation.

AWs can be used to deduce a significance of a microservice. After defining weights and performing inference, Aws can be used to determine a significance of corresponding microservices.

A total aggregated weight of all AWs of the microservice (TAW) can indicate reflect the microservice's significance for the system accessibility, and can facilitate ordering the microservices accordingly to the TAW metric.

In addition, a normalized accessibility weight (NAW) can indicate a relation of a microservice's TAW metric to the aggregated TAWs of entire system.

The system can have a predefined policy to select the group of the microservices for the chaos testing according to their position in the list ordered according to NAW. For example, take top 5% of the list or just top 20 microservices or all microservices with NAW>0.1.

### Example Architectures, Tables, and Flows

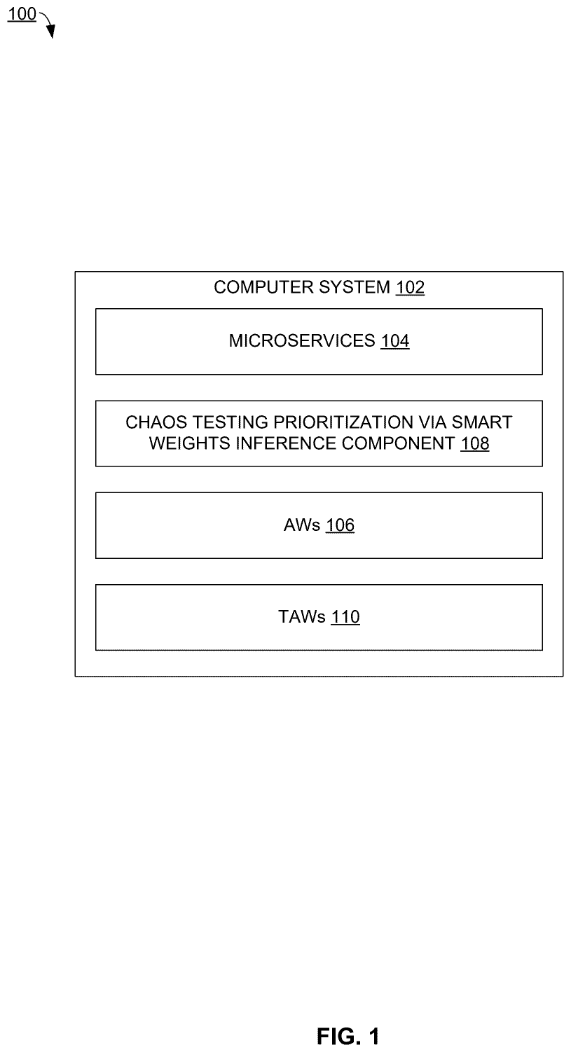

FIG. 1 illustrates an example system architecture 100 that can facilitate chaos testing prioritization via smart weights inference, in accordance with an embodiment of this disclosure.

System architecture 100 comprises computer system 102, microservices 104, AWs 106, chaos testing prioritization via smart weights inference component 108, and TAWs 110.

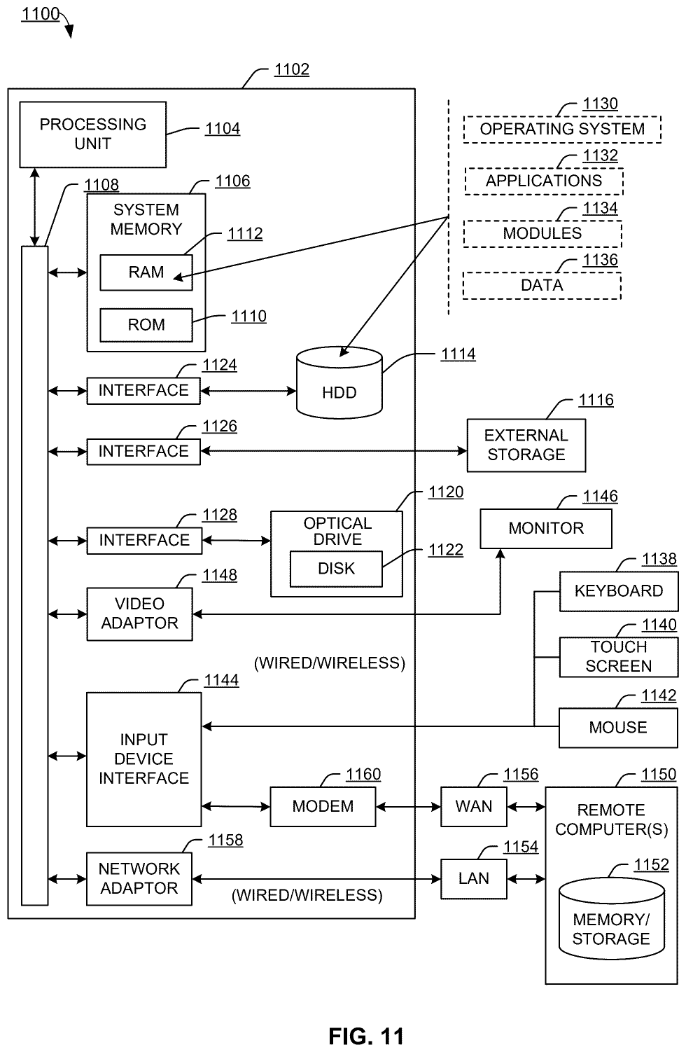

Computer system 102 can be implemented with part(s) of computing environment 1100 of FIG. 11.

Chaos testing prioritization via smart weights inference component 108 can identify AWs (e.g., AWs 106) for APIs of microservices 104, infer AWs where an API's AW is not specified, determine TAWs (e.g., TAWs 110) from the AWs, and use those TAWs to determine where to introduce chaos testing in microservices 104.

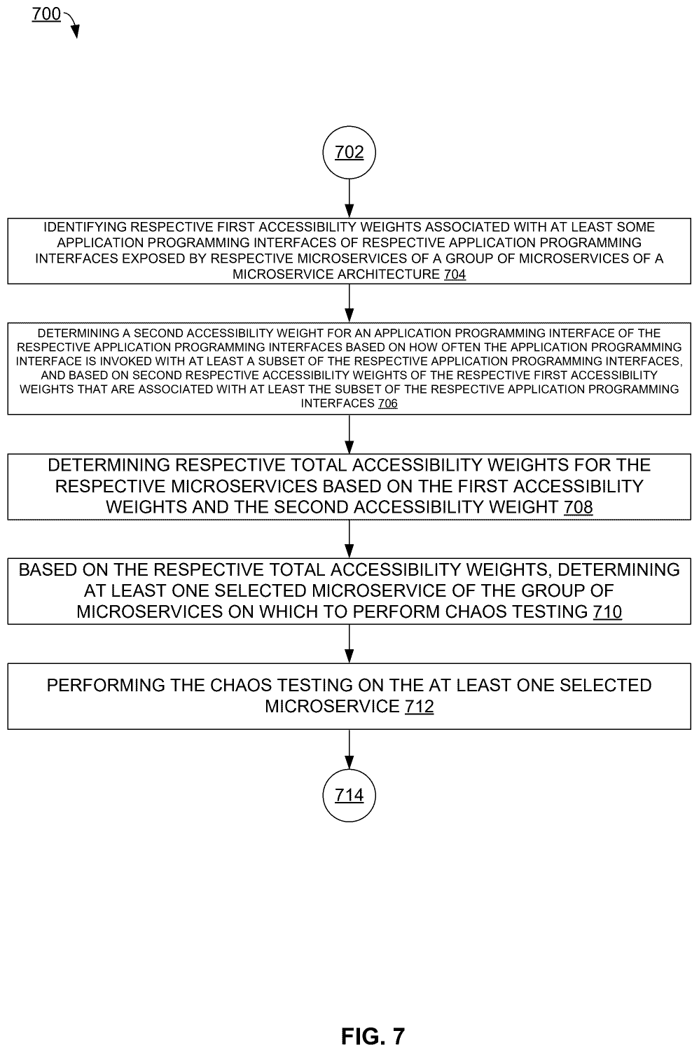

In some examples, chaos testing prioritization via smart weights inference component 108 can implement part(s) of the process flows of FIGS. 7-10 to facilitate chaos testing prioritization via smart weights inference.

It can be appreciated that system architecture 100 is one example system architecture for chaos testing prioritization via smart weights inference, and that there can be other system architectures that facilitate chaos testing prioritization via smart weights inference.

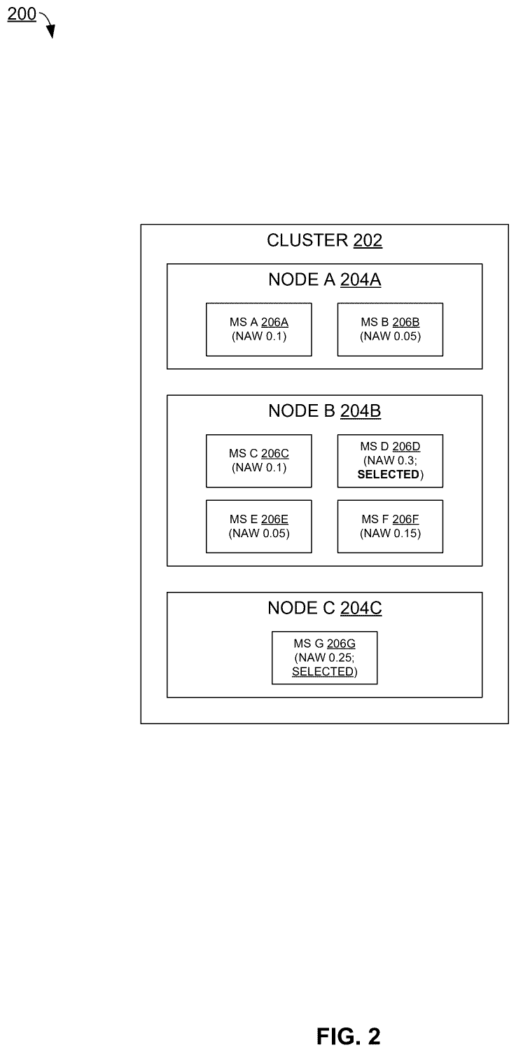

FIG. 2 illustrates an example 200 that can facilitate chaos testing prioritization via smart weights inference, in accordance with an embodiment of this disclosure. In some examples, part(s) of example 200 can be used to implement part(s) of system architecture 100 of FIG. 1.

Example 200 comprises cluster 202, which comprises node A 204A, node B 204B, and node C 204C. These nodes execute microservices that have various NAW values. These microservices are MS A 206A (NAW 0.1), MS B 206B (NAW 0.05), MS C 206C (NAW 0.1), MS D 206D (NAW 0.3; selected), MS E 206E (NAW 0.05), MS F 206F (NAW 0.15), and MS G 206G (NAW 0.25; selected).

In example 200, the standard for selecting microservices for chaos testing is those microservices with the top-two NAW values. Here, these are MS D 206D (NAW 0.3; selected), and MS G 206G (NAW 0.25; selected).

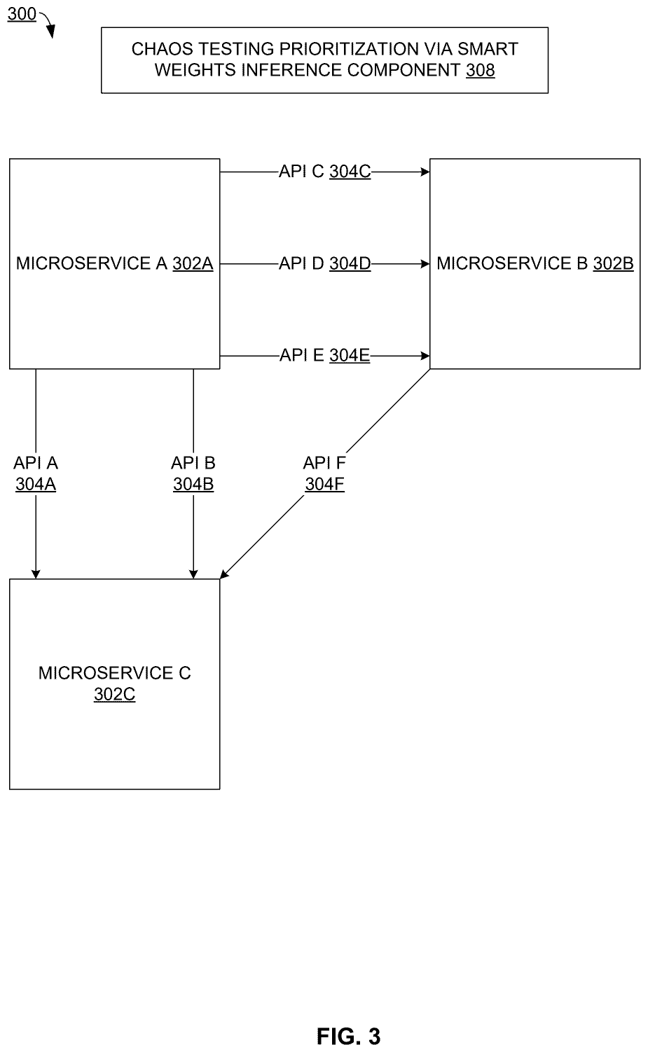

FIG. 3 illustrates an example 300 of weights for microservice application programming interfaces, and that can facilitate chaos testing prioritization via smart weights inference, in accordance with an embodiment of this disclosure. In some examples, part(s) of example 300 can be used to implement part(s) of system architecture 100 of FIG. 1.

Example 300 comprises microservice A 302A, microservice B 302B, and microservice C 302C, and chaos testing prioritization via smart weights inference component 308 (which can be similar to chaos testing prioritization via smart weights inference component 108 of FIG. 1). In turn, the microservices expose various APIs. Microservice A 302A exposes API A 304A and API B 304B (which are invoked by microservice C 302C); and exposes API C 304C, API D 304D, and API E 304E (which are invoked by microservice B 302B). Microservice B 302B exposes microservice F 304F (which is invoked by microservice C 302C).

Chaos testing prioritization via smart weights inference component 308 can use AWs specified by some of these microservices to infer AWs for other of these microservices, determine corresponding TAWs for the microservices, and use the TAWs to determine where to introduce chaos for the microservices.

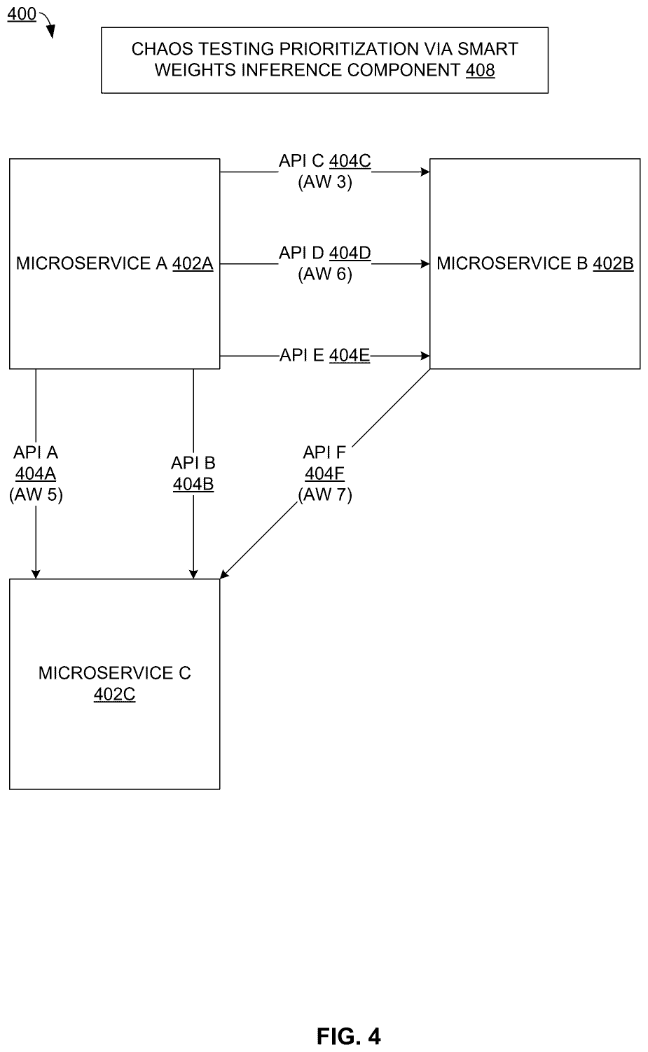

FIG. 4 illustrates an example 400 of specified weights for microservice application programming interfaces, and that can facilitate chaos testing prioritization via smart weights inference, in accordance with an embodiment of this disclosure. In some examples, part(s) of example 400 can be used to implement part(s) of system architecture 100 of FIG. 1.

Example 400 comprises microservice A 402A, microservice B 402B, and microservice C 402C, API A 404A, API B 404B, API C 404C, API D 404D, API E 404E, microservice F 404F, and chaos testing prioritization via smart weights inference component 408. These parts of example 400 can be similar to microservice A 302A, microservice B 302B, and microservice C 302C, API A 304A, API B 304B, API C 304C, API D 304D, API E 304E, microservice F 304F, and chaos testing prioritization via smart weights inference component 308 of FIG. 3, respectively.

In example 400, some APIs have AWs specified by the respective microservice's owner. API A 304A has been assigned an AW of 5, API C 304C has been assigned an AW of 3, API D 304D has been assigned an AW of 6, and API F 304F has been assigned an AW of 7.

Chaos testing prioritization via smart weights inference component 308 can use these specified AWs to infer AWs for other of these microservices, determine corresponding TAWs for the microservices, and use the TAWs to determine where to introduce chaos for the microservices.

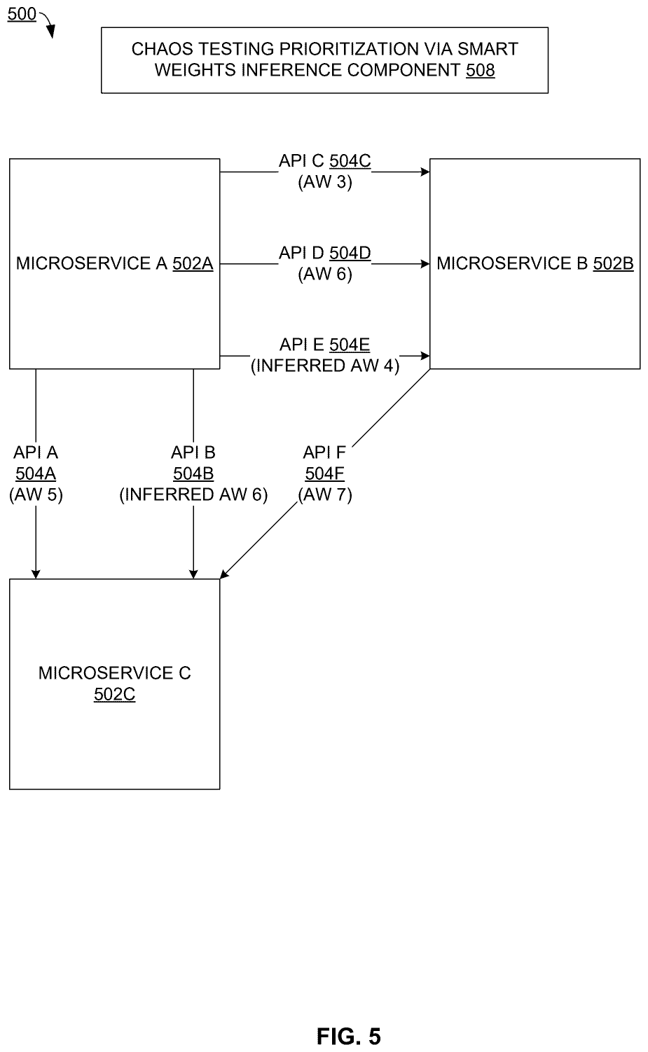

FIG. 5 illustrates an example 500 of inferred weights for microservice application programming interfaces, and that can facilitate chaos testing prioritization via smart weights inference, in accordance with an embodiment of this disclosure. In some examples, part(s) of example 500 can be used to implement part(s) of system architecture 100 of FIG. 1.

Example 500 comprises microservice A 502A, microservice B 502B, and microservice C 502C, API A 504A, API B 504B, API C 504C, API D 504D, API E 504E, microservice F 504F, and chaos testing prioritization via smart weights inference component 508. These parts of example 500 can be similar to microservice A 302A, microservice B 302B, and microservice C 302C, API A 304A, API B 304B, API C 304C, API D 304D, API E 304E, microservice F 304F, and chaos testing prioritization via smart weights inference component 308 of FIG. 3, respectively.

In example 500, some APIs that did not have AWs specified for them (as in example 400 of FIG. 4) now have their AWs inferred, based on how often they are invoked with other APIs. Here, API B 304B has an inferred AW of 4, and API E 304E has an inferred AW of 6.

Chaos testing prioritization via smart weights inference component 308 can use the specified AWs for APIs and these inferred AWs for APIs to determine corresponding TAWs for the microservices, and use the TAWs to determine where to introduce chaos for the microservices.

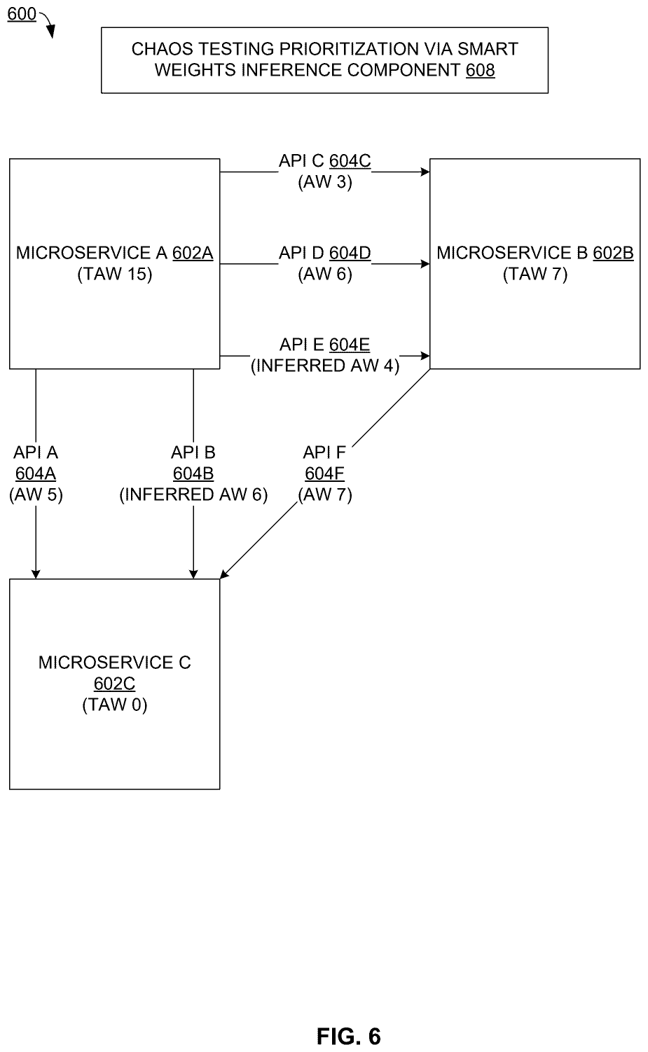

FIG. 6 illustrates an example 600 of determining weights for microservices based on weights for microservice application programming interfaces, and that can facilitate chaos testing prioritization via smart weights inference, in accordance with an embodiment of this disclosure. In some examples, part(s) of example 600 can be used to implement part(s) of system architecture 100 of FIG. 1.

Example 600 comprises microservice A 602A, microservice B 602B, and microservice C 602C, API A 604A, API B 604B, API C 604C, API D 604D, API E 604E, microservice F 604F, and chaos testing prioritization via smart weights inference component 608. These parts of example 400 can be similar to microservice A 302A, microservice B 302B, and microservice C 302C, API A 304A, API B 304B, API C 304C, API D 304D, API E 304E, microservice F 304F, and chaos testing prioritization via smart weights inference component 308 of FIG. 3, respectively.

In example 600, TAWs for microservices have been determined based on the specified AWs and inferred AWs of example 400 of FIG. 4 and example 500 of FIG. 5.

Chaos testing prioritization via smart weights inference component 308 can use the microservices'TAWS determine where to introduce chaos for the microservices (e.g., to introduce chaos at those microservices with the highest TAW values).

### Example Process Flows

FIG. 7 illustrates an example process flow 700 for fault optimization, and that can facilitate chaos testing prioritization via smart weights inference, in accordance with an embodiment of this disclosure. In some examples, one or more embodiments of process flow 700 can be implemented by system architecture 100 of FIG. 1, or computing environment 1100 of FIG. 11.

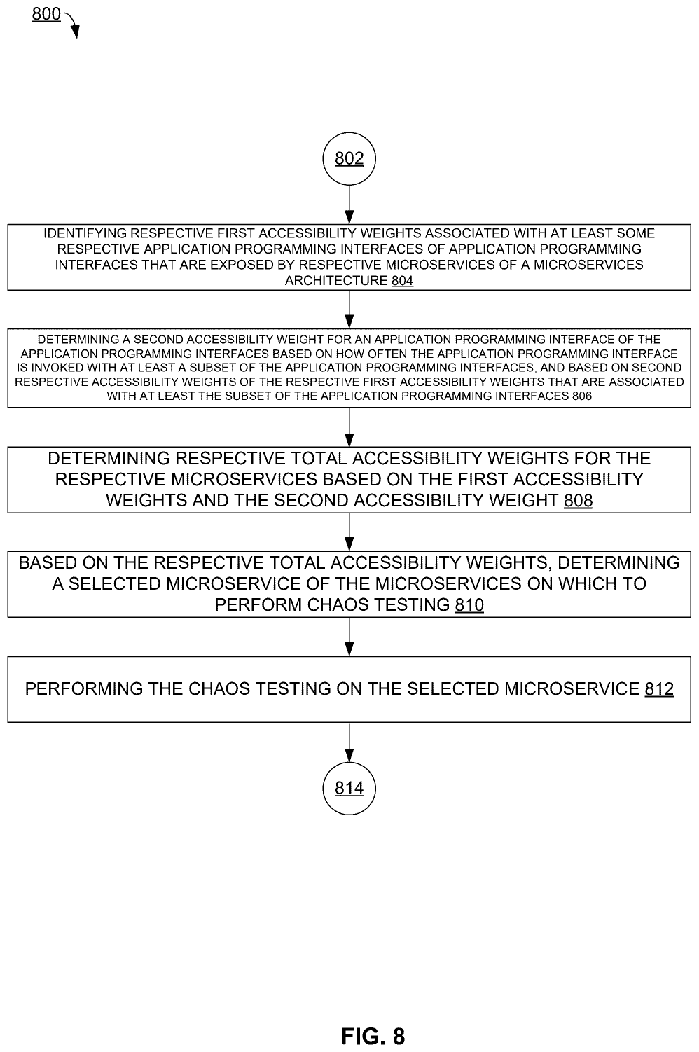

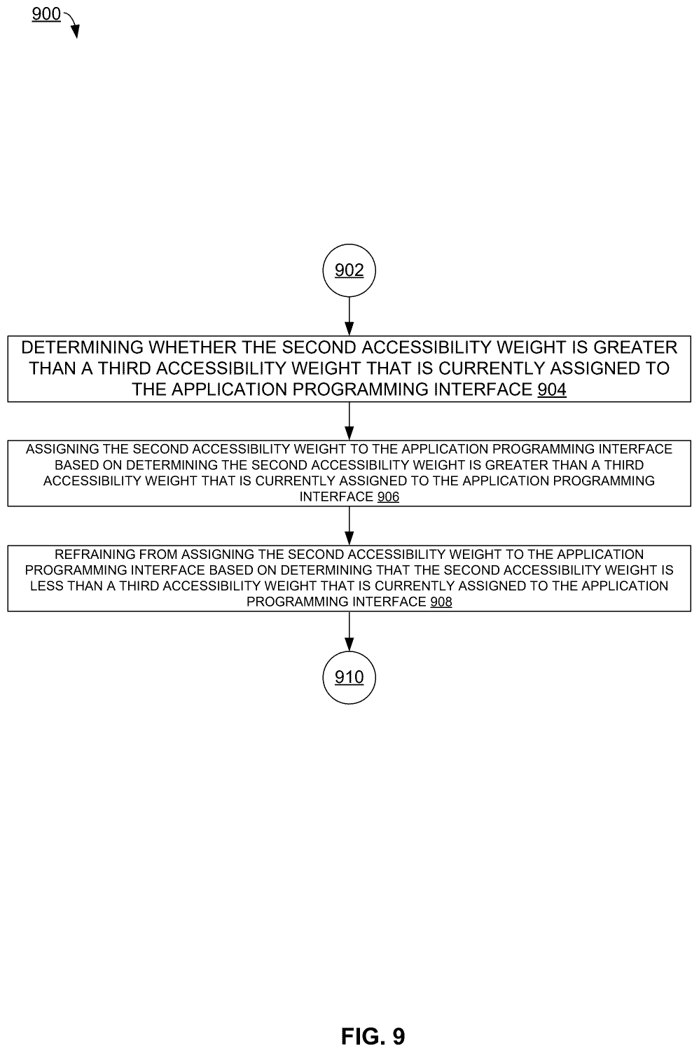

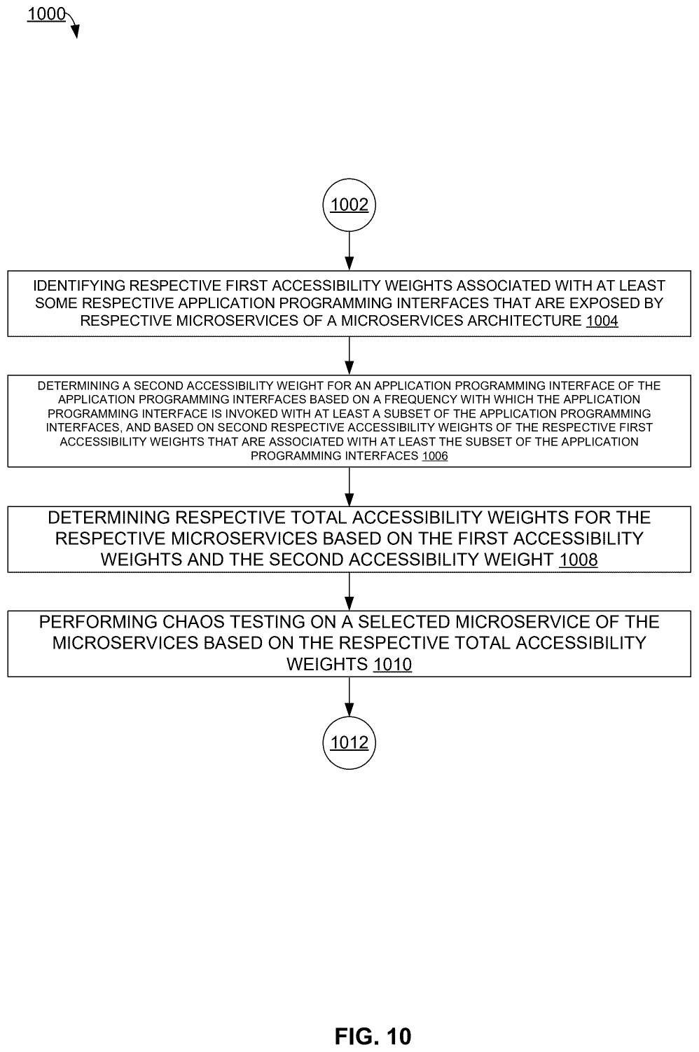

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 800 of FIG. 8, process flow 900 of FIG. 9, and/or process flow 1000 of FIG. 10.

Process flow 700 begins with 702, and moves to operation 704.

Operation 704 depicts identifying respective first accessibility weights associated with at least some application programming interfaces of respective application programming interfaces exposed by respective microservices of a group of microservices of a microservice architecture. This can comprise determining which APIs have AWs that have been specified, such as by an API developer.

After operation 704, process flow 700 moves to operation 706.

Operation 706 depicts determining a second accessibility weight for an application programming interface of the respective application programming interfaces based on how often the application programming interface is invoked with at least a subset of the respective application programming interfaces, and based on second respective accessibility weights of the respective first accessibility weights that are associated with at least the subset of the respective application programming interfaces. This can comprise inferring AWs for APIs based on the AW values from operation 704.

In some examples, the determining of the second accessibility weight is based on respective products of how often the application programming interface is invoked with at least the subset of the respective application programming interfaces and the second respective accessibility weights. That is, in some examples, each API A that is invoked X % of time with any of the critical APIs having weight W, will get weight candidate of W*X/100. Where there are many critical APIs to which API A is correlated, the result of this determination can be aggregated across all of them.

After operation 706, process flow 700 moves to operation 708.

Operation 708 depicts determining respective total accessibility weights for the respective microservices based on the first accessibility weights and the second accessibility weight. This can comprise determining TAWs for microservices based on the AWs of the microservices'APIs.

After operation 708, process flow 700 moves to operation 710.

Operation 710 depicts based on the respective total accessibility weights, determining at least one selected microservice of the group of microservices on which to perform chaos testing. This can comprise selecting a microservice for chaos testing based on the TAW values of operation 708 (e.g., selecting a microservice with a highest TAW value).

In some examples, operation 710 comprises normalizing the respective total accessibility weights to produce respective normalized total accessibility weights, and the determining of the at least one selected microservice on which to perform the chaos testing is based on the respective normalized total accessibility weights. That is, TAWs can be normalized to produce NTAWs.

In some examples, the determining of the at least one selected microservice on which to perform the chaos testing is based on selecting a defined number of microservices of the group of microservices that satisfy a top total accessibility weight criterion. That is, the selection of microservices for chaos testing can be the X microservices with the top TAWs.

In some examples, the determining of the at least one selected microservice on which to perform the chaos testing is based on selecting a defined percentage of microservices of the group of microservices that satisfy a top total accessibility weight criterion. That is, the selection of microservices for chaos testing can be the X % of microservices with the top TAWs.

In some examples, the determining of the at least one selected microservice on which to perform the chaos testing is based on selecting a subset of the group of microservices that satisfy a top total accessibility weight criterion, independent of a number of microservices in the subset. That is, the selection of microservices for chaos testing can be those microservices with TAWs>X.

After operation 710, process flow 700 moves to operation 712.

Operation 712 depicts performing the chaos testing on the at least one selected microservice. This can comprise performing chaos testing on the microservice selected in operation 710.

In some examples, operation 712 comprises introducing a failure to a determined part of the microservice architecture, and measuring an ability of the microservice architecture to overcome the failure according to a defined criterion or a defined metric.

After operation 712, process flow 700 moves to 714, where process flow 700 ends.

FIG. 8 illustrates an example process flow 800 for fault optimization, and that can facilitate chaos testing prioritization via smart weights inference, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 700 of FIG. 7, process flow 900 of FIG. 9, and/or process flow 1000 of FIG. 10.

Process flow 800 begins with 802, and moves to operation 804.

Operation 804 depicts identifying respective first accessibility weights associated with at least some respective application programming interfaces of application programming interfaces that are exposed by respective microservices of a microservices architecture. In some examples, operation 804 can be implemented in a similar manner as operation 704 of FIG. 7.

In some examples, the first accessibility weights are determined based on user input data. That is, a microservice's owner can specify the AWs of APIs that that microservice exposes.

In some examples, the user input data is first user input data, the first user input data is associated with a first user account that is associated with creating a microservice that corresponds to the first accessibility weights, and the first accessibility weights are determined based on second user input data that is indicative of approval of the first accessibility weights associated with a second user account that is configured to administer the microservices. That is, an administrator of the microservices architecture can approve specified AW values.

In some examples, the user input data is first user input data, the first user input data is associated with a first user account that is associated with creating a microservice that corresponds to the first accessibility weights, and the first accessibility weights are determined based on second user input data that is indicative of modifying the first user input data associated with a second user account that is configured to administer the microservices. That is, an administrator of the microservices architecture can modify AW values that are specified by a microservice's owner.

After operation 804, process flow 800 moves to operation 806.

Operation 806 depicts determining a second accessibility weight for an application programming interface of the application programming interfaces based on how often the application programming interface is invoked with at least a subset of the application programming interfaces, and based on second respective accessibility weights of the respective first accessibility weights that are associated with at least the subset of the application programming interfaces. In some examples, operation 806 can be implemented in a similar manner as operation 706 of FIG. 7.

In some examples, the application programming interface is a first application programming interface, the determining of the second accessibility weight for the first application programming interface is performed based on the first application programming interface being deemed critical according to a criticality criterion, operation 806 comprises refraining from determining a third accessibility weight for a second application programming interface of the application programming interfaces based on determining that the second application programming interface omits an indication of being deemed critical according to the criticality criterion. That is, it can be that accessibility weights are only determined for certain APIs, such as those that are deemed to be critical.

After operation 806, process flow 800 moves to operation 808.

Operation 808 depicts determining respective total accessibility weights for the respective microservices based on the first accessibility weights and the second accessibility weight. In some examples, operation 808 can be implemented in a similar manner as operation 708 of FIG. 7.

After operation 808, process flow 800 moves to operation 810.

Operation 810 depicts based on the respective total accessibility weights, determining a selected microservice of the microservices on which to perform chaos testing. In some examples, operation 810 can be implemented in a similar manner as operation 710 of FIG. 7.

After operation 810, process flow 800 moves to operation 812.

Operation 812 depicts performing the chaos testing on the selected microservice. In some examples, operation 812 can be implemented in a similar manner as operation 712 of FIG. 7.

After operation 812, process flow 800 moves to 814, where process flow 800 ends.

FIG. 9 illustrates an example process flow 900 for fault optimization, and that can facilitate chaos testing prioritization via smart weights inference, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 700 of FIG. 7, process flow 800 of FIG. 8, and/or process flow 1000 of FIG. 10.

Process flow 900 begins with 902, and moves to operation 904.

Operation 904 depicts determining whether the second accessibility weight is greater than a third accessibility weight that is currently assigned to the application programming interface.

Where it is determined in operation 904 that the second accessibility weight is greater than the third accessibility weight that is currently assigned to the application programming interface, process flow 900 moves to operation 906. Instead, it is determined in operation 904 that the second accessibility weight is not greater than the third accessibility weight that is currently assigned to the application programming interface, process flow 900 moves to operation 908.

Operation 906 is reached from operation 904 where it is determined in operation 904 that the second accessibility weight is greater than the third accessibility weight that is currently assigned to the application programming interface. Operation 906 depicts assigning the second accessibility weight to the application programming interface based on determining the second accessibility weight is greater than a third accessibility weight that is currently assigned to the application programming interface.

After operation 906, process flow 900 moves to 910, where process flow 900 ends.

Operation 908 is reached from operation 904 where it is determined in operation 904 that the second accessibility weight is not greater (or is less than) than the third accessibility weight that is currently assigned to the application programming interface.

Operation 908 depicts refraining from assigning the second accessibility weight to the application programming interface based on determining that the second accessibility weight is less than a third accessibility weight that is currently assigned to the application programming interface.

After operation 908, process flow 900 moves to 910, where process flow 900 ends.

In this manner, process flow 900 can be implemented such that, if an inferred AW is greater than the API's current AW, the API can be assigned the inferred AW. And otherwise, the current AW can be used for the API instead of the inferred AW.

FIG. 10 illustrates an example process flow 1000 for fault optimization, and that can facilitate chaos testing prioritization via smart weights inference, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 700 of FIG. 7, process flow 800 of FIG. 8, and/or process flow 1000 of FIG. 10.

Process flow 1000 begins with 1002, and moves to operation 1004.

Operation 1004 depicts identifying respective first accessibility weights associated with at least some respective application programming interfaces that are exposed by respective microservices of a microservices architecture. In some examples, operation 1004 can be implemented in a similar manner as operation 704 of FIG. 7.

In some examples, the application programming interfaces are first application programming interfaces, and second application programming interfaces of at least the subset of the application programming interfaces are marked as critical. That is, it can be that the present techniques are implemented on a subset of APIs in a microservices architecture, such as those that are deemed to be critical.

After operation 1004, process flow 1000 moves to operation 1006.

Operation 1006 depicts determining a second accessibility weight for an application programming interface of the application programming interfaces based on a frequency with which the application programming interface is invoked with at least a subset of the application programming interfaces, and based on second respective accessibility weights of the respective first accessibility weights that are associated with at least the subset of the application programming interfaces. In some examples, operation 1006 can be implemented in a similar manner as operation 706 of FIG. 7.

In some examples, operation 1006 comprises performing iterations of the determining of the second accessibility weight for the application programming interface. In some examples, the iterations are performed based on a schedule. In some examples, respective iterations of the iterations are initiated based on information specified by user input data. That is, iterations of determining AWs (and performing selective chaos testing based on AWs) can be performed over time. In some examples, these iterations can be performed on a schedule (e.g., once every 15 minutes). In other examples, an iteration can be performed on demand by a user.

In some examples, operation 1006 comprises determining the frequency with which the application programming interface is invoked with at least the subset of the application programming interfaces based on tracking user sessions that interact with the microservices architecture. That is, a rate of invocation of various APIs can be determined based on tracking user sessions.

After operation 1006, process flow 1000 moves to operation 1008.

Operation 1008 depicts determining respective total accessibility weights for the respective microservices based on the first accessibility weights and the second accessibility weight. In some examples, operation 1008 can be implemented in a similar manner as operation 708 of FIG. 7.

After operation 1008, process flow 1000 moves to operation 1010.

Operation 1010 depicts performing chaos testing on a selected microservice of the microservices based on the respective total accessibility weights. In some examples, operation 1010 can be implemented in a similar manner as operations 710-712 of FIG. 7.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer system 102 of FIG. 1.

In some examples, computing environment 1100 can implement one or more embodiments of the process flows of FIGS. 7-10 to facilitate chaos testing prioritization via smart weights inference.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the. NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B”is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
identifying respective first accessibility weights associated with at least some application programming interfaces of respective application programming interfaces exposed by respective microservices of a group of microservices of a microservice architecture;
determining a second accessibility weight for an application programming interface of the respective application programming interfaces based on how often the application programming interface is invoked with at least a subset of the respective application programming interfaces, and based on second respective accessibility weights of the respective first accessibility weights that are associated with at least the subset of the respective application programming interfaces;
determining respective total accessibility weights for the respective microservices based on the first accessibility weights and the second accessibility weight;
based on the respective total accessibility weights, determining at least one selected microservice of the group of microservices on which to perform chaos testing; and
performing the chaos testing on the at least one selected microservice.

2. The system of claim 1, wherein the performing of the chaos testing comprises:
introducing a failure to a determined part of the microservice architecture; and
measuring an ability of the microservice architecture to overcome the failure according to a defined criterion or a defined metric.

3. The system of claim 1, wherein the operations further comprise:
normalizing the respective total accessibility weights to produce respective normalized total accessibility weights; and
wherein the determining of the at least one selected microservice on which to perform the chaos testing is based on the respective normalized total accessibility weights.

4. The system of claim 1, wherein the determining of the at least one selected microservice on which to perform the chaos testing is based on selecting a defined number of microservices of the group of microservices that satisfy a top total accessibility weight criterion.

5. The system of claim 1, wherein the determining of the at least one selected microservice on which to perform the chaos testing is based on selecting a defined percentage of microservices of the group of microservices that satisfy a top total accessibility weight criterion.

6. The system of claim 1, wherein the determining of the at least one selected microservice on which to perform the chaos testing is based on selecting a subset of the group of microservices that satisfy a top total accessibility weight criterion, independent of a number of microservices in the subset.

7. The system of claim 1, wherein the determining of the second accessibility weight is based on respective products of how often the application programming interface is invoked with at least the subset of the respective application programming interfaces and the second respective accessibility weights.

8. A method, comprising:
identifying, by a system comprising at least one processor, respective first accessibility weights associated with at least some respective application programming interfaces of application programming interfaces that are exposed by respective microservices of a microservices architecture;
determining, by the system, a second accessibility weight for an application programming interface of the application programming interfaces based on how often the application programming interface is invoked with at least a subset of the application programming interfaces, and based on second respective accessibility weights of the respective first accessibility weights that are associated with at least the subset of the application programming interfaces;
determining, by the system, respective total accessibility weights for the respective microservices based on the first accessibility weights and the second accessibility weight;
based on the respective total accessibility weights, determining, by the system, a selected microservice of the microservices on which to perform chaos testing; and
performing, by the system, the chaos testing on the selected microservice.

9. The method of claim 8, further comprising:
assigning, by the system, the second accessibility weight to the application programming interface based on determining the second accessibility weight is greater than a third accessibility weight that is currently assigned to the application programming interface.

10. The method of claim 8, further comprising:
refraining, by the system, from assigning the second accessibility weight to the application programming interface based on determining that the second accessibility weight is less than a third accessibility weight that is currently assigned to the application programming interface.

11. The method of claim 8, wherein the first accessibility weights are determined based on user input data.

12. The method of claim 11, wherein the user input data is first user input data, wherein the first user input data is associated with a first user account that is associated with creating a microservice that corresponds to the first accessibility weights, and wherein the first accessibility weights are determined based on second user input data that is indicative of approval of the first accessibility weights associated with a second user account that is configured to administer the microservices.

13. The method of claim 11, wherein the user input data is first user input data, wherein the first user input data is associated with a first user account that is associated with creating a microservice that corresponds to the first accessibility weights, and wherein the first accessibility weights are determined based on second user input data that is indicative of modifying the first user input data associated with a second user account that is configured to administer the microservices.

14. The method of claim 8, wherein the application programming interface is a first application programming interface, wherein the determining of the second accessibility weight for the first application programming interface is performed based on the first application programming interface being deemed critical according to a criticality criterion, and further comprising:
refraining, by the system, from determining a third accessibility weight for a second application programming interface of the application programming interfaces based on determining that the second application programming interface omits an indication of being deemed critical according to the criticality criterion.

15. A non-transitory computer-readable medium comprising instructions that, in response to execution, cause a system comprising at least one processor to perform operations, comprising:
identifying respective first accessibility weights associated with at least some respective application programming interfaces that are exposed by respective microservices of a microservices architecture;
determining a second accessibility weight for an application programming interface of the application programming interfaces based on a frequency with which the application programming interface is invoked with at least a subset of the application programming interfaces, and based on second respective accessibility weights of the respective first accessibility weights that are associated with at least the subset of the application programming interfaces;
determining respective total accessibility weights for the respective microservices based on the first accessibility weights and the second accessibility weight; and
performing chaos testing on a selected microservice of the microservices based on the respective total accessibility weights.

16. The non-transitory computer-readable medium of claim 15, wherein the application programming interfaces are first application programming interfaces, and wherein second application programming interfaces of at least the subset of the application programming interfaces are marked as critical.

17. The non-transitory computer-readable medium of claim 15, wherein the operations further comprise:
performing iterations of the determining of the second accessibility weight for the application programming interface.

18. The non-transitory computer-readable medium of claim 17, wherein the iterations are performed based on a schedule.

19. The non-transitory computer-readable medium of claim 17, wherein respective iterations of the iterations are initiated based on information specified by user input data.

20. The non-transitory computer-readable medium of claim 15, wherein the operations further comprise:
determining the frequency with which the application programming interface is invoked with at least the subset of the application programming interfaces based on tracking user sessions that interact with the microservices architecture.
